(19) United States
(12) Patent Application Publication
(10) Pub. No.: US 2011/0132634 A1
(43) Pub. Date: Jun. 9, 2011

(54) OUTLET COVER WITH INTEGRAL SUPPORT STRUCTURE

(76) Inventor: Lynn Fetzer-Westmeister, Shelby, OH (US)

(21) Appl. No.: 12/633,214

(22) Filed: Dec. 8, 2009

(51) Int. Cl. H02G 3/14

(52) U.S. Cl. 174/66

(57) ABSTRACT

An outlet cover may comprise a plate member adapted to cover and be secured to a power outlet, the plate portion including at least one fastener aperture and at least one outlet aperture; and at least one supporting structure extending from the plate portion, the supporting structure selected from the group consisting of a shelf portion, a hook, and a recess configured to receive an electronic device. If the supporting structure is a shelf member, the shelf member may extend approximately ninety degrees from the plate member, may be monolithic with the plate member, and/or may include a non-slip surface. The shelf portion further may comprise an extension member, which increases the distance between the shelf and the plate member.

### FIELD OF INVENTION

The present invention relates to outlet covers, and more particularly, to outlet covers that have a particular configuration to assist in holding and/or storing items.

### BACKGROUND OF THE INVENTION

Currently, outlet covers are used for aesthetic purposes to hide power outlets and the hole in a wall created for power outlets. The term “power outlet” is generally intended to be inclusive rather than exclusive, and may include, without limitation, electrical/power outlets, switch outlets, and combinations of the two. Similarly, “outlet cover” is also intended to be inclusive of, without limitation, power outlet covers, switchplates or toggle plates, blank plates, push button covers, and combination covers.

Outlet covers may vary with color, style, and shape to better suit the homeowner's needs. However, even though outlet covers may be a form of expression, issues arise with respect to their placement within the home. The issues perhaps are most relevant with respect to electronic devices that need charged periodically, like cell phones, portable music players, pagers, and any of a plurality of other devices. However, issues also arise for appliances or extension cords that are plugged in to a power outlet for longer periods of time.

For example, power outlets may be located near different types of furniture such as couches, tables, desks, etc., which forces the appliance or device to either be placed on the floor or on top of the furniture. Alternatively, the outlet may not be located near any furniture, and the appliance or electronic device may be forced to be placed on the floor. If the electronic device is placed on top of the furniture it takes up space and may accidentally fall off and break. If the electronic device is placed on the floor it may accidentally be stepped on.

As mentioned, there are also issues with extension and power cords. Whether the electronic device is on top of furniture or on the floor, power cords will be leading from the power outlet to the electronic device, in order to be recharged. These power cords may create hazards and may also cause injuries if tripped upon. With extension cords, there is a need to be able to store all or only a portion of the power cord when the cord is in use and when the cord is not in use.

Accordingly, there is a need for an outlet cover that is able to hold electronic devices, objects, appliances, and/or power cords.

### SUMMARY OF THE INVENTION

The embodiments of the present invention pertain to outlet covers, which may cover power outlets.

In one embodiment, an outlet cover comprises a plate member adapted to cover and be secured to a power outlet, the plate member including at least one fastener aperture and at least one outlet aperture. The outlet cover further comprises at least one supporting structure extending from the plate portion, where the supporting structure is selected from the group consisting of a shelf portion, a hook, and a recess configured to receive an electronic device.

In another embodiment, an outlet cover comprises a plate member adapted to cover a power outlet, where the plate member including an interference fit mechanism configured to attach to a power outlet and at least one outlet aperture. The outlet cover also comprises least one supporting structure extending from the plate portion, where the supporting structure selected from the group consisting of a shelf portion, a hook, and a recess configured to receive an electronic device.

In still a further embodiment, a method of providing electrical power to a device, comprises the steps of providing an outlet cover attached to a power outlet, the outlet cover including a plate member and at least one support structure integral with the plate member, the at least one support structure selected from the group consisting of a shelf portion, a hook, and a recess configured to receive an electronic device, placing an electrical device onto the support structure; and plugging the electrical device into the power outlet.

### BRIEF DESCRIPTION OF THE DRAWINGS

FIG. 1A is a perspective view of a first embodiment of an outlet cover.

FIG. 1B is a perspective view of a second embodiment of an outlet cover.

FIG. 2A is a perspective view of a third embodiment of an outlet cover.

FIG. 2B is a perspective view of a fourth embodiment of an outlet cover.

FIG. 3A is a perspective view of a fifth embodiment of an outlet cover.

FIG. 3B is a perspective view of a sixth embodiment of an outlet cover.

FIG. 4A is a perspective view of a seventh embodiment of an outlet cover.

FIG. 4B is a perspective view of a eighth embodiment of an outlet cover.

FIG. 5A is a perspective view of a ninth embodiment of an outlet cover.

FIG. 5B is a perspective view of a tenth embodiment of an outlet cover.

FIG. 6A is a perspective view of a eleventh embodiment of an outlet cover.

FIG. 6B is a perspective view of a twelfth embodiment of an outlet cover.

FIG. 6C is a perspective view of a thirteenth embodiment of an outlet cover.

FIG. 6D is a perspective view of a fourteenth embodiment of an outlet cover.

FIG. 7A is a perspective view of a fifteenth embodiment of an outlet cover.

FIG. 7B is a perspective view of a sixteenth embodiment of an outlet cover.

FIG. 7C is a perspective view of a seventeenth embodiment of an outlet cover.

FIG. 7D is a perspective view of a eighteenth embodiment of an outlet cover.

FIG. 8A is a perspective view of a nineteenth embodiment of an outlet cover.

FIG. 8B is a perspective view of a twentieth embodiment of an outlet cover.

FIG. 8C is a perspective view of a twenty-first embodiment of an outlet cover.

FIG. 8D is a perspective view of a twenty-second embodiment of an outlet cover.

FIG. 9A is a perspective view of a twenty-third embodiment of an outlet cover.

FIG. 9B is a perspective view of a twenty-fourth embodiment of an outlet cover.

FIG. 10A is a perspective view of a twenty-fifth embodiment of an outlet cover.

FIG. 10B is a perspective view of a twenty-sixth embodiment of an outlet cover.

FIG. 11A is a perspective view of a twenty-seventh embodiment of an outlet cover.

FIG. 11B is a perspective view of a twenty-eighth embodiment of an outlet cover.

FIG. 11C is a perspective view of a twenty-ninth embodiment of an outlet cover.

FIG. 12 is a perspective view of a thirtieth embodiment of an outlet cover.

FIG. 13A is a perspective exploded view of an outlet cover and power outlet.

FIG. 13B is a perspective exploded view of another outlet cover and power outlet.

FIG. 14A is a perspective view of a thirty-first embodiment of an outlet cover.

FIG. 14A is a perspective view of a thirty-second embodiment of an outlet cover.

FIG. 15A is a perspective view of a thirty-third embodiment of an outlet cover.

FIG. 15B is a perspective view of a thirty-fourth embodiment of an outlet cover.

### DETAILED DESCRIPTION

Generally, in one or more embodiments, an outlet cover may comprise a plate portion, at least one outlet aperture, at least one fastener aperture, and at least one support structure. The support structure may be, for example, a shelf, a hook, or a pocket configured to hold an electronic device, such as a laptop computer. The outlet cover may be constructed from plastics, metals, or any of a plurality of other materials.

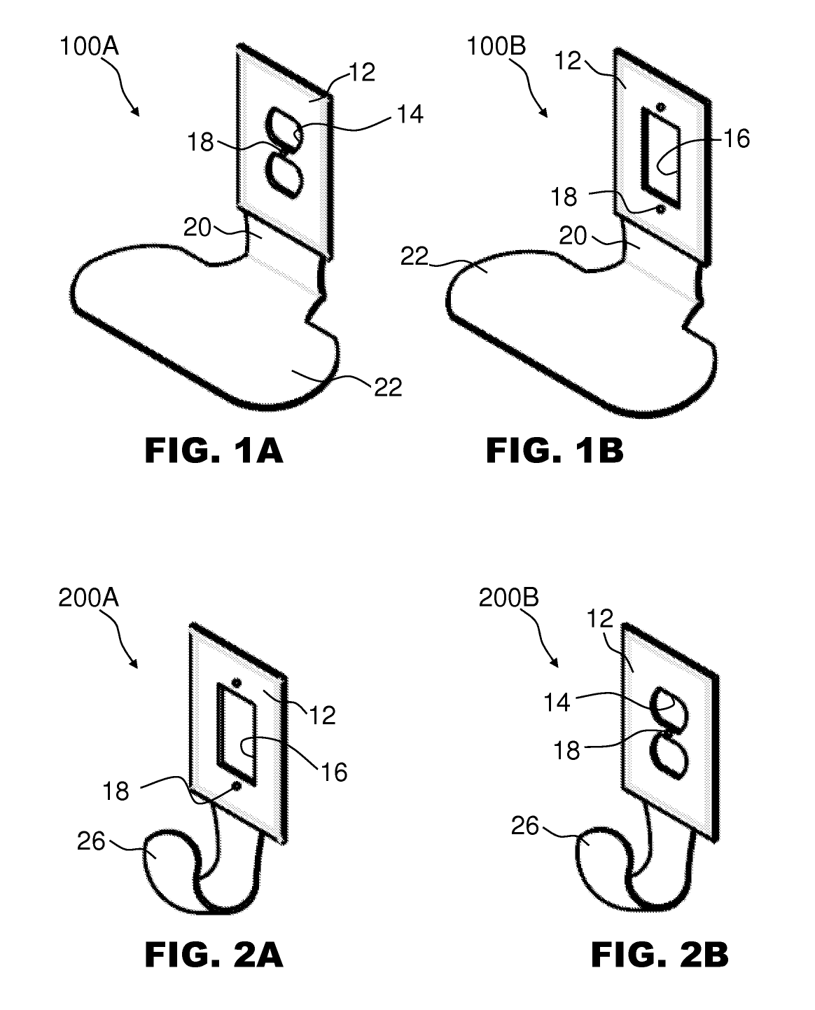

Referring now to the drawings wherein the showings are for purposes of illustrating embodiments of the invention only and not for purposes of limiting the same, FIGS. 1A-1B show embodiments of an outlet cover, specifically outlet covers 100A and 100B. The outlet cover 100A may comprise a plate portion 12, at least one outlet aperture 14, at least one fastener aperture 18, an extension member 20, and a shelf portion 22. The outlet cover 100B may comprise a plate portion 12, an outlet aperture 16, two fastener apertures 18, an extension member 20, and a shelf portion 22. Plate portion 12 and the shelf portion 22 may be joined by any means that may be realized by persons of ordinary skill in the art, such as gluing, heating, melting, stamping, and pressing. In one particular embodiment, the plate portion 12 and shelf portion 22 are monolithic. The plate portion 12 and the shelf portion 22 may be constructed of metal or a plastic material such as polyethylene, polyvinyl chloride, or any number of materials that may be realized by persons of ordinary skill in the art.

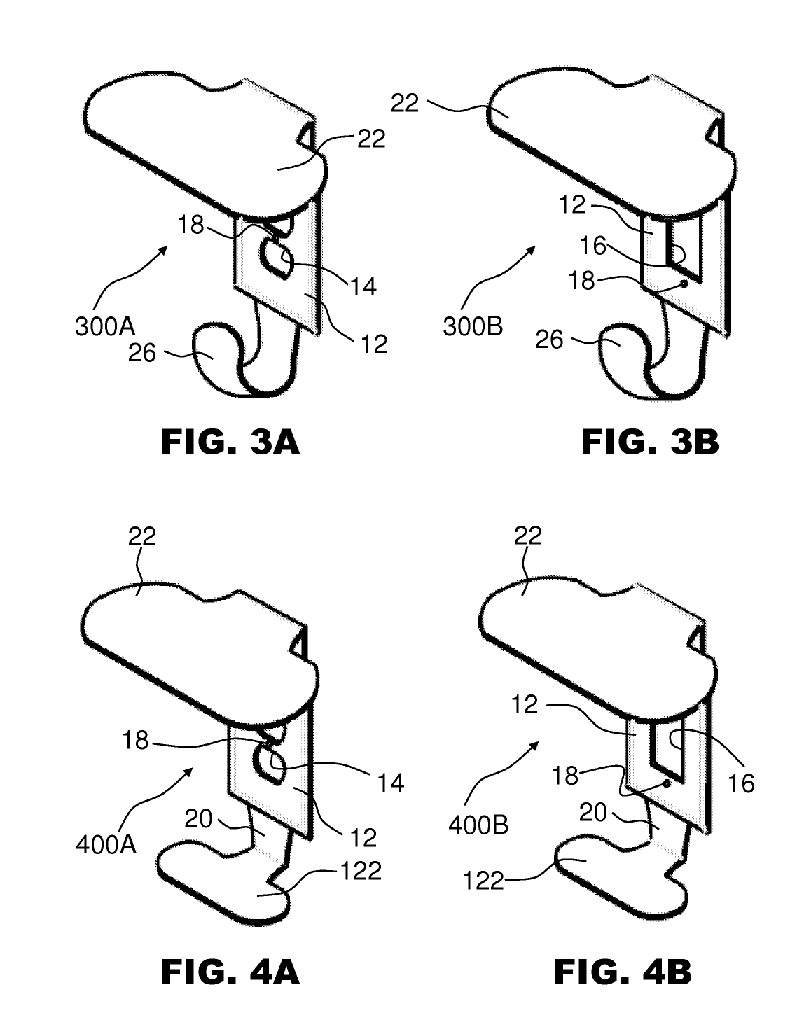

The dimensions of the plate portion may vary so that the plate portion covers and fits the respective power outlet. For example, in some embodiments, the plate portion is standard a size, like a duplex outlet plate, such that the width of the plate portion 12 is smaller than the height of the plate portion 2. Alternatively, as will be discussed in more detail below, the plate portion may be wider, to fit two duplex outlet covers, multi-toggle switchplates, combination toggle/outlet plates, or any of a plurality of other size/function covers. The dimensions of the shelf portion may also vary depending on the space required. The shelf portion may be large enough to support items such as Palm Pilots, PDAs, hand held gaming systems, cell phones, walkie talkies, and any other items that may be realized by persons of ordinary skill in the art. For example, as illustrated in FIGS. 1A-1B, shelf portion 22 is larger, and shelf portion 122, illustrated in FIG. 3D, is smaller.

In the embodiment of FIGS. 1A-1B, the shelf portion 22 has curved or rounded edges, but different shaped edges may be utilized, such as square edges. Additionally, the upper surface of the shelf portion 22 may be equipped with a retaining member such as a non-slip surface such as silicone, anti-slip tapes, epoxy, anti-slip paint, polyurethane, and any other material that may be realized by persons of ordinary skill in the art. Alternatively or additionally, the retaining member may further include a wall extending upward from the surface of the shelf portion at the perimeter of the shelf portion. Extending wall may be solid, embossed with a pattern, or may have sections removed for aesthetic purposes, depending upon a user's desired purpose.

As illustrated in the FIGS., the shelf portion 22, 122 may extend perpendicularly relative to the plate portion, that is at an angle of about ninety degrees from the face of the plate portion. In such an embodiment, the shelf portion 22, 122 will typically be oriented substantially horizontally when the outlet cover is fastened to a power outlet. It is also contemplated that the shelf portion 22, 122 and/or the extension member 20 may comprise an optional embossment or fold at the transition between the extension member and shelf, which would stiffen the shelf and enable it to support greater weight. Alternatively or additionally, extension member 20 may comprise at least one rib member for reinforcing the extension member, which may in turn permit shelf portion 22, 122 to support greater weight.

With continued reference to FIG. 1A, in this embodiment, the at least one outlet aperture 14 is a combination of two apertures (duplex) 14, but more or less apertures may be utilized depending on the number of apertures required. The size of the outlet aperture 14 may also be large enough to comfortably fit around the outer edge of a power socket. Additionally, the fastener apertures 18 may be a hole or opening that allows a screw, nail, staple, or any other fastener that may be realized by persons of ordinary skill in the art to secure the outlet cover 100A, 100B to a power outlet. Outlet cover 100A comprises a single fastener aperture 18, but any number fasteners may be utilized depending on the amount of support required. As an example, outlet cover 100B comprises two fastener apertures 18.

Alternatively, it is contemplated that the outlet cover may simply “snap” onto the power outlet or onto an existing power outlet cover, such as by an interference fit between the outlet cover and the power outlet. The interference fit mechanism may be, for example, a detent locking mechanism. Specifically, the detent locking mechanism may be a plurality of tabs configured to fit in compression within a corresponding plurality of slots or a ball detent mechanism. Such a configuration may desirable in instances where the outlet cover is ornamented with a specific design and a user may want to quickly remove and replace one outlet cover with another. For example, a holiday-themed outlet cover may be installed in the winter, which may be replaced by a flower-themed outlet cover during the spring season. In such instances, the outlet cover may be selectively removable from the power outlet.

With reference to FIGS. 1A-1B, the outlet cover 100A, 100B may optionally comprise extension member 20 that extends between the plate portion 12 and shelf portion 22, 122 and joins the plate portion 12 to the shelf portion 22, 122. The extension member 20 may extend in any one or more directions relative to the plate portion. In one embodiment, the extension member 20 extends outwardly from a side of the plate portion, and then angles towards the shelf portion. The extension member 20 may be of the same material as the plate portion 20 and the shelf portion 23.

With reference to FIGS. 2A-2B, perspective views of outlet covers 200A-200B are shown. The outlet cover 200A may comprise a plate portion 12, at least one outlet aperture 16, at least one fastener aperture 18, and a hook portion 24. The outlet cover 200B may comprise a plate portion 12, at least one outlet aperture 14, at least one fastener aperture 18, and a hook portion 24. In this embodiment, the plate portion 112 and the hook portion 123 may be joined by any means that may be realized by persons of ordinary skill in the art such as gluing, heating, melting, stamping, and pressing. Moreover, the plate portion 112 and the hook portion 123 may be constructed of a plastic material such as polyethylene, polyvinyl chloride, and any number of materials that may be realized by persons of ordinary skill in the art.

With continued reference to FIG. 2A, in this embodiment 200A the aperture is one rectangular shaped aperture 16, but more and different shaped apertures may be utilized depending on the number and shape of apertures required. For example, the embodiment 200B of FIG. 2B comprises two apertures 14. The size of the aperture(s) 14, 16 may also be large enough to comfortably fit around the outer edge of a power socket. Additionally, in the embodiment 200A, the fastener aperture 18 is a combination of two apertures, but more or less fasteners may be utilized depending on the amount necessary to support the outlet cover. The fastener aperture 18 may also be any hole or opening that allows a screw, nail, staple, or any other material that may be realized by persons of ordinary skill in the art to secure the outlet cover to a power outlet.

With continuing reference to FIGS. 2A-2B, the dimensions of the plate portion 12 may vary and be selected so that the plate portion 12 may fully cover the power outlet. The width of the plate portion 12 may also be longer than the height of the plate portion 12 and vice versa. Moreover, the dimensions of the hook portion 26 may also vary depending on the intended size and weight of the object the hook portion 26 is meant to support. For example, if an object that is not heavy is meant to be supported, then the hook portion's 26 thickness and width may be small. On the other hand, if the object that is meant to be supported is heavy, then the hook portion's 26 thickness and width may be large.

With continued reference to FIGS. 2A-2B, in these embodiments, the hook portion 26 may extend outwardly from the bottommost portion of the plate portion 12 and may transition into a curved structure. The hook portion 26 may allow the outlet cover 200A, 200B to support extension cords, power lines, power cables, keys, purses, jackets, clothes, and any other article that may be realized by persons of ordinary skill in the art. Furthermore, one end of the hook portion 26, in this embodiment, may a curved edge and no square edges. However, different shaped edges may be utilized, such as square edges and any other shaped edges that may be realized by persons of ordinary skill in the art.

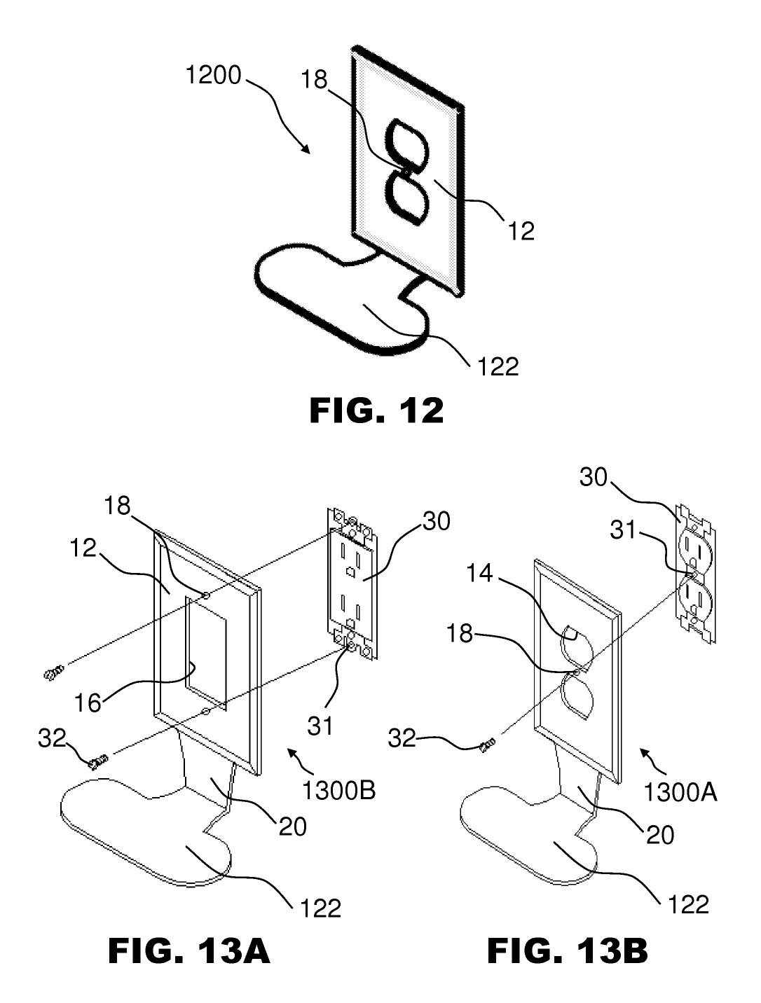

With reference to FIGS. 3A-3B, perspective views of an outlet covers 300A and 300B are shown. These embodiments may comprise an outlet cover with both a hook and a shelf attached. Outlet cover 300A may comprise a plate portion 12, a hook portion 26, at least one fastener aperture 18, a shelf portion 22, an extension member 20, and at least one outlet aperture 14. Outlet cover 300B may comprise a plate portion 12, a hook portion 26, at least one fastener aperture 18, a shelf portion 22, an extension member 20, and at least one outlet aperture 16. In these embodiments, the plate portion 12, the extension member 20, the shelf 22, and the hook portion 26 may be joined by any means that may be realized by persons of ordinary skill in the art such as gluing, heating, melting, stamping, and pressing. Alternatively, the plate portion 12, the extension member 20, the shelf, and the hook portion 26 may be monolithic, or any combination of monolithic and joined. The plate portion 12, the shelf portion 22, the extension member 20, and the hook portion 26 may also be constructed of a plastic material such as polyethylene, polyvinyl chloride, and any number of materials that may be realized by persons of ordinary skill in the art. As with all embodiments that include a shelf, it is also contemplated that extension member 20 be omitted, as illustrated in FIG. 12, as described later.

With continued reference to FIGS. 3A-3B, in these embodiments, the outlet aperture may be a combination of two apertures 14 (300A), but more or less different shaped apertures may be utilized depending on the number and shape of apertures required, such as the single outlet aperture 16 of outlet cover 300B. The size of the apertures 14 may also be large enough to comfortably fit around the outer edge of a power socket or light switch. Additionally, outlet cover 300A may comprise a single fastener aperture 18, but more or less fasteners may be utilized depending on the amount of support necessary to support the outlet cover 300A. The fastener aperture 18 may be a hole or opening that allows a screw, nail, staple, or any other material that may be realized by persons of ordinary skill in the art to secure the outlet cover 300A to a power outlet.

The dimensions of the plate portion 12 of embodiments 300A-300B may vary so that the plate portion 12 may fully cover the power outlet. For example, the height of the plate portion 12 may be longer than the width of the plate portion 12, and vice versa. Moreover, the dimensions of the hook portion 24 may also vary depending on how heavy of an object the hook portion 26 is meant to support. For example, if an object that is not heavy is meant to be supported, then the hook portion's 26 thickness and width may be small. On the other hand, if the object that is meant to be supported is heavy, then the hook portion's 26 thickness and width may be larger. The dimensions of the shelf portion 22 may also vary depending on how large of a space is required. The shelf portion 22 may be large enough to support items such as Palm Pilots, PDAs, hand held gaming systems, cell phones, walkie talkies, and any other items that may be realized by persons of ordinary skill in the art. In this embodiment, the shelf portion 22 has curved edges, but different shaped edges may be utilized, such as square edges. The upper surface of the shelf portion 22 may also be equipped with a non-slip surface such as silicone, anti-slip tapes, epoxy, anti-slip paint, polyurethane, and any other material that may be realized by persons of ordinary skill in the art.

With continued reference to FIGS. 3A-3B, in these embodiments, the hook portion 26 may extend outwardly from the bottommost portion of the plate portion 12 and may transition into a curved structure. The hook portion 26 may allow the outlet cover 300A, 300B to support extension cords, power lines, power cables, keys, purses, jackets, clothes, and any other article that may be realized by persons of ordinary skill in the art. Furthermore, in these embodiments the end of the hook portion 26 has a curved edge rather than squared edges. However, different shaped edges may be utilized, such as square edges and any other shaped edges that may be realized by persons of ordinary skill in the art. Furthermore, rather than a single hook 26, it is contemplated that multiple hooks could extend from the plate member 12.

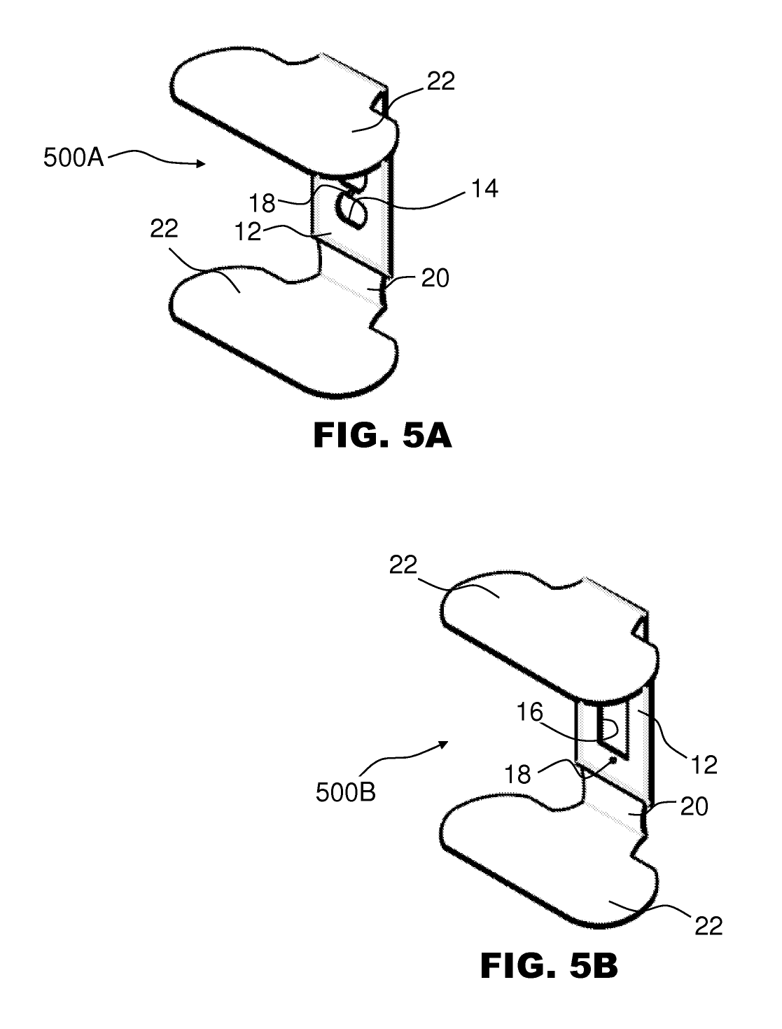

Rather than hook 26, a smaller shelf 24 could also be utilized, as illustrated in outlet covers 400A and 400B shown in FIGS. 4A-4B. Alternatively, two larger shelves 22 could be attached to opposite ends of the plate member 12, as illustrated in outlet covers 500A-500B, shown in FIGS. 5A-5B.

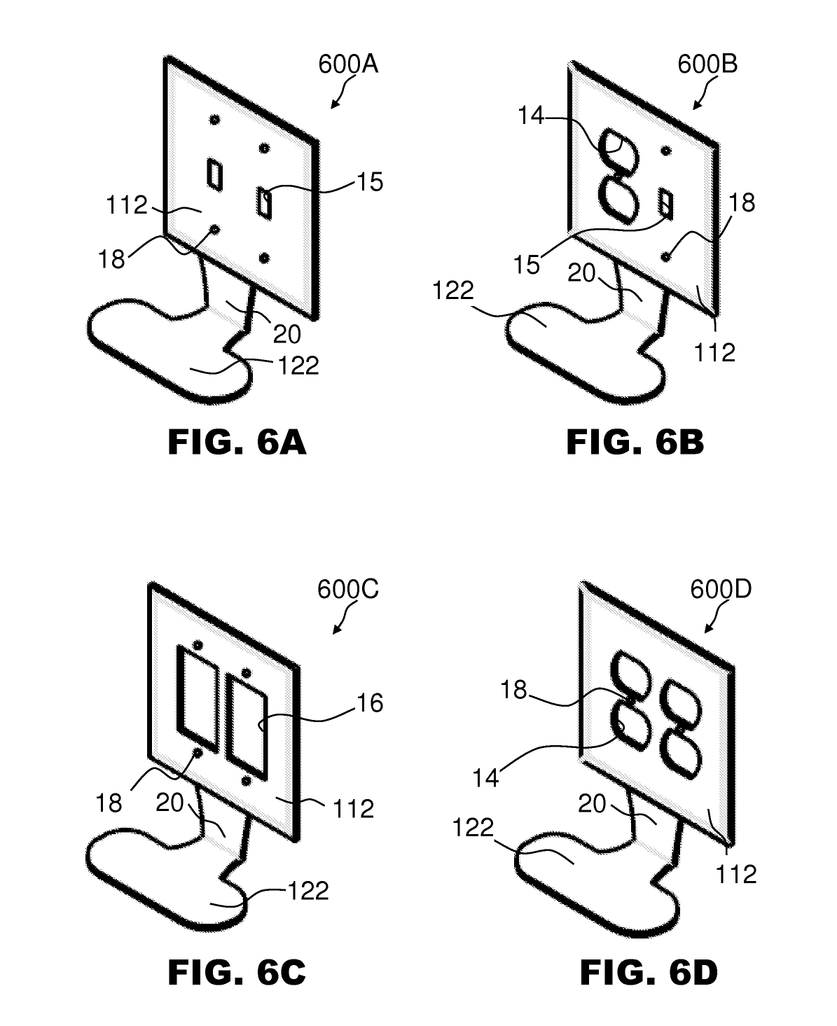

Still further, it is contemplated that different sized and configured plate members could be used in particular embodiments, and the different plate members may be combined with different combinations of larger shelves 22, smaller shelves 122, and hooks 26. For example, outlet cover 600A, shown in FIG. 6A, comprises a smaller shelf 122 extending from a double plate member 112 having two switch apertures 15. Outlet cover 600B, shown in FIG. 6B, comprises a smaller shelf 122 extending from a double plate member 112 having two outlet apertures 14 and one switch aperture 15. Outlet cover 600C, shown in FIG. 6C, comprises a smaller shelf 122 extending from a double plate member 112 having two outlet apertures 16. Outlet cover 600D, shown in FIG. 6D, comprises a smaller shelf 122 extending from a double plate member 112 having four outlet apertures 14.

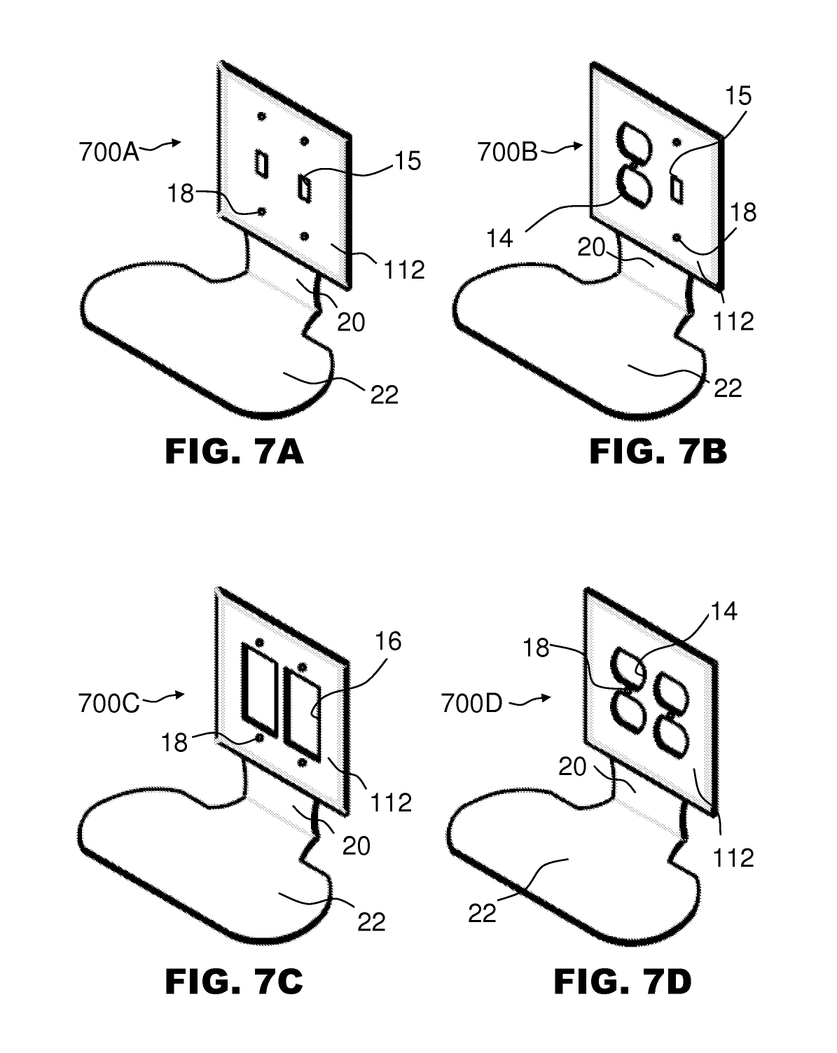

Outlet cover 700A, shown in FIG. 7A, comprises a larger shelf 22 extending from a double plate member 112 having two switch apertures 15. Outlet cover 700B, shown in FIG. 7B, comprises a larger shelf 22 extending from a double plate member 112 having two outlet apertures 14 and one switch aperture 15. Outlet cover 700C, shown in FIG. 7C, comprises a larger shelf 22 extending from a double plate member 112 having two outlet apertures 16. Outlet cover 700D, shown in FIG. 7D, comprises a larger shelf 22 extending from a double plate member 112 having four outlet apertures 14.

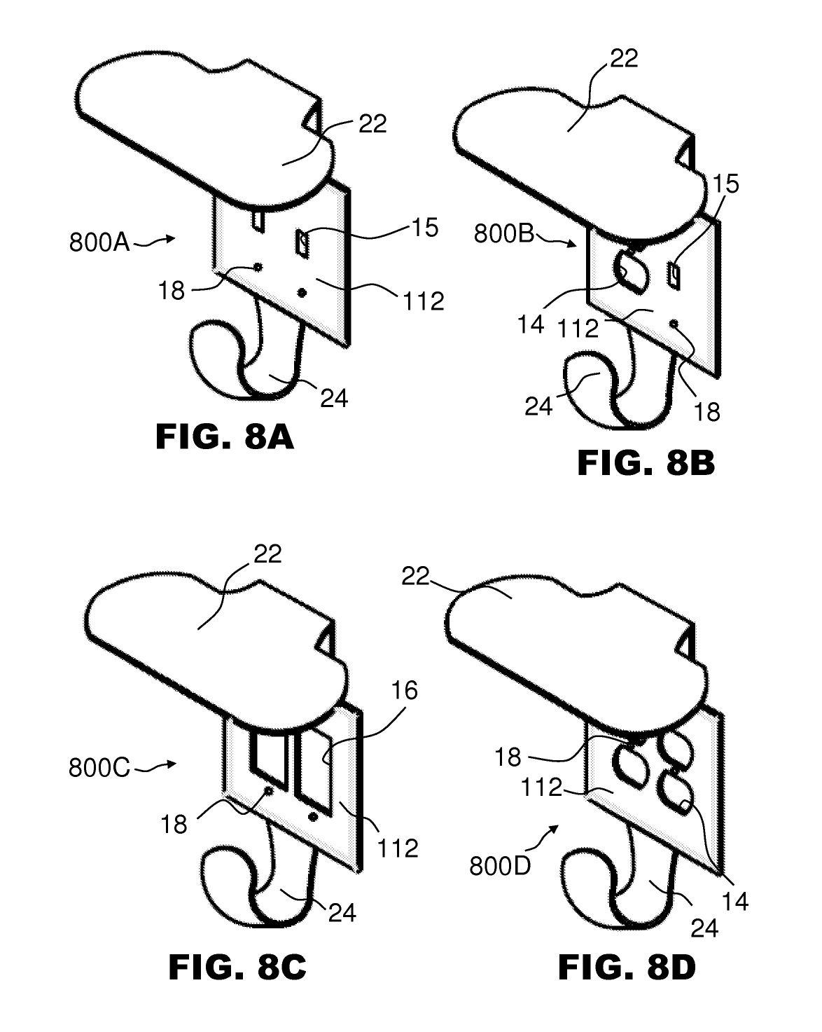

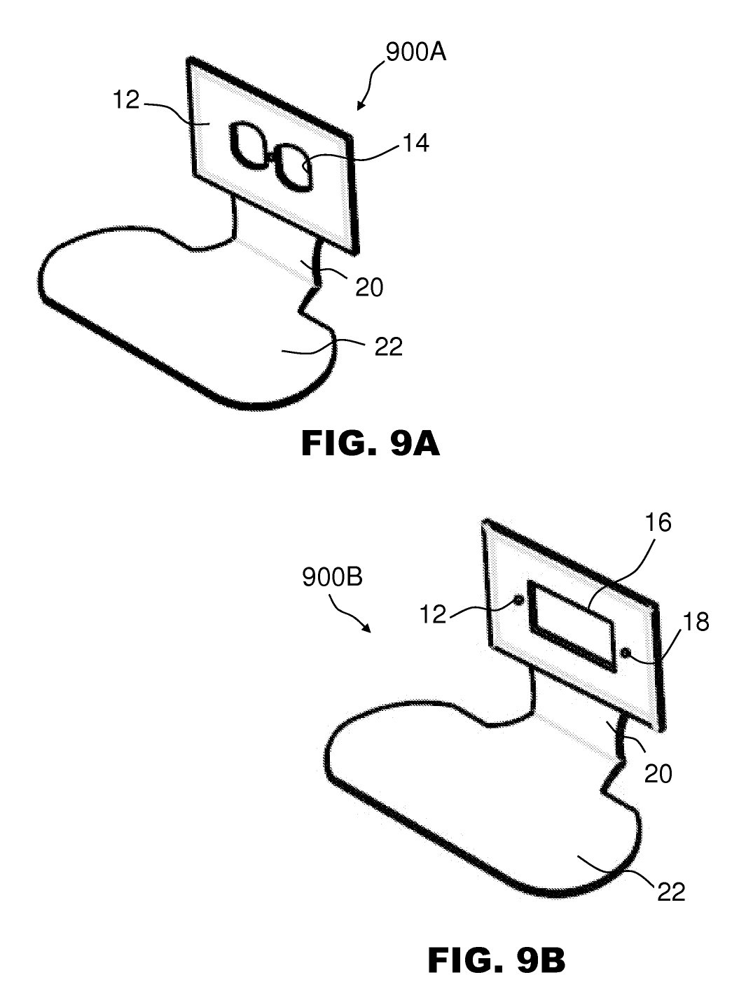

Outlet cover 800A, shown in FIG. 8A, comprises a larger shelf 22 and hook member 24 extending from opposite ends of a double plate member 112 having two switch apertures 15. Outlet cover 800B, shown in FIG. 8B, comprises a larger shelf 22 and hook member 24 extending from opposite ends of a double plate member 112 having two outlet apertures 14 and one switch aperture 15. Outlet cover 800C, shown in FIG. 8C, comprises a larger shelf 22 and hook member 24 extending from opposite ends of a double plate member 112 having two outlet apertures 16. Outlet cover 800D, shown in FIG. 8D, comprises a larger shelf 22 and hook member 24 extending from opposite ends of a double plate member 112 having four outlet apertures 14.

It is also contemplated that the shelf may extend from the side of the outlet cover, which may be useful for horizontally-attaching outlet covers. For example, outlet cover 900A comprises a small shelf 122 extending from the side of a plate member 12 having two outlet apertures 14. Outlet cover 900B comprises a small shelf 122 extending from the side of a plate member 12 having one outlet aperture 16. Rather or in addition to a shelf extending from the plate member, hook member 26 could also be utilized. Furthermore, rather than shelf 22, 122 or hook 26 extending from the side of the plate member, it is also contemplated that an attachment flange may extend from the side of the plate member, with the attachment flange comprising at least one aperture that receives a fastener. The attachment flange can be configured such that the fasteners that extend through the flange can engage the wall stud to which the power outlet is attached.

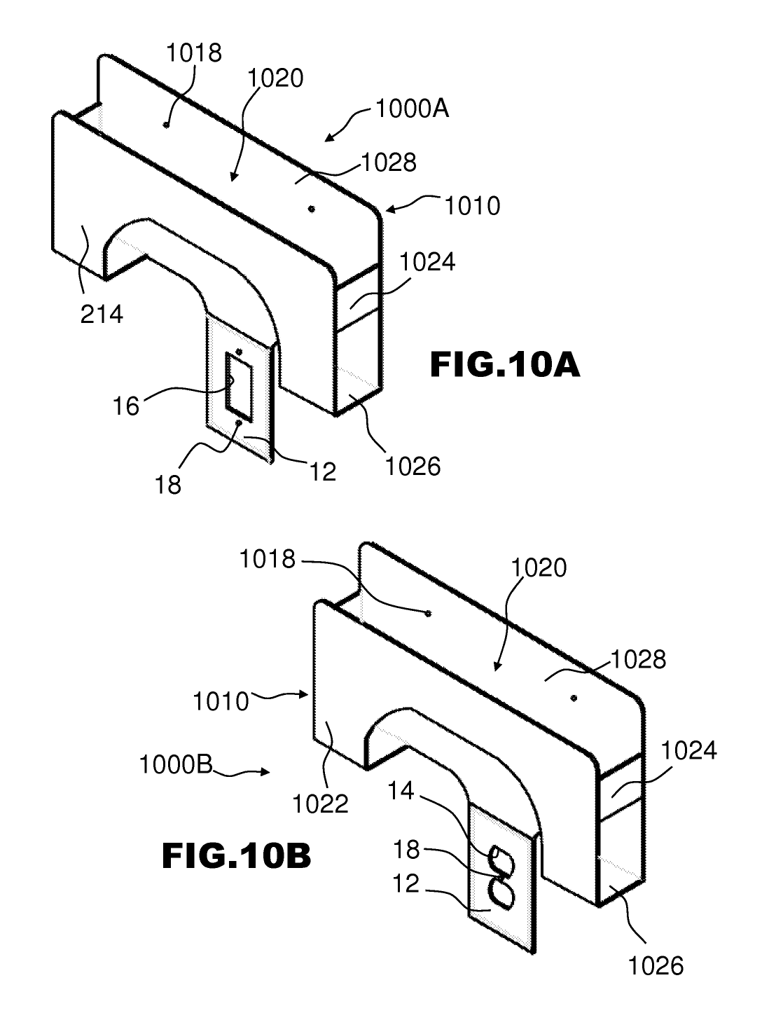

With reference to FIGS. 10A-10B, perspective views of an outlet cover 1000A, 1000B are shown. The outlet cover 1000A may comprise a plate portion 12, at least one outlet aperture 16, at least one fastener aperture 18, and a laptop computer holder 1010. The outlet cover 1000B may comprise a plate portion 12, at least one outlet aperture 14, at least one fastener aperture 18, and a laptop computer holder 1010.

The laptop holder 1010 may comprise a recess 1020 that receives a laptop computer (not shown) such that the laptop is supported within the recess while it is charging. In one embodiment, the recess 1020 may be formed by front wall 1022, side braces 1024, bottom supports 1026, and rear wall 1028. As illustrated in FIGS. 10A-10B, the rear wall 1028 may be contiguous or attached to plate portion 12. In these embodiments, the plate portion 12 and the rear wall 1028 may be joined by any means that may be realized by persons of ordinary skill in the art such as gluing, heating, melting, stamping, and pressing. Alternatively, the rear wall 1028 and plate portion 12 may be monolithic.

Furthermore, the plate portion 12, the front wall 1022, the side braces 1024, the bottom wall 1026, and the rear wall 1028 may also be joined by the means stated above, formed monolithically, or any combination of the two. The plate portion 12, the front wall 1022, the side braces 1024, the bottom wall 1026, and the rear wall 1028 may be constructed of a plastic material such as polyethylene, polyvinyl chloride, and any number of materials that may be realized by persons of ordinary skill in the art. With reference to FIG. 10A, in this embodiment 1000A, the outlet aperture 16 is a single aperture, but more and different shaped apertures may be utilized depending on the number and shape of apertures required. Embodiment 1000B, for example, comprises two outlet apertures 14. The size of the aperture 16 may also be large enough to comfortably fit around the outer edge of a power socket or light switch.

Outlet covers 100A, 100B may comprise a plurality of fastener apertures, which receive fasteners to secure the outlet cover 100A, 100B to the power outlet and optionally to a wall. The fasteners 18 in the plate portion 12 may be similar to those in other embodiments, and may include a hole or opening that receives a screw, nail, staple, or any other material that may be realized by persons of ordinary skill in the art to secure the outlet cover 1000A, 1000B to a power outlet. However, embodiments 1000A, 1000B may additionally comprise one or more optional fastener apertures 1018 that provide additional support to outlet cover 1000A, 1000B. Apertures 1018 may receive a screw, nail, staple, or any other material that may be realized by persons of ordinary skill in the art to secure the outlet cover 1000A, 1000B to, for example, a wall. In order to allow fastener apertures 1018 to the wall, it is contemplated that rear wall 1028 may be at least slightly taller than front wall 1022, with apertures 1018 located above the upper extent of front wall 1022. At least one of the fastener apertures 1018 optionally may be configured to overlay the wall stud to which the power outlet attaches, and therefore a fastener extending through the particular aperture can engage the wall stud, to provide a secure attachment for outlet cover 1000A, 1000B and support for heavy objects.

Also, in these embodiments 1000A, 1000B, the side brace 1024 comprises two side braces 1024, one on each side, but more side braces 1024 or larger side braces may be utilized. For example, the side brace may simply be a continuous side wall that extends from the upper end of the front wall 1022 to the bottom wall 1026. Additionally, as illustrated, the bottom supports 1026 may have a space between them so that the power cord can extend from the laptop to the power outlet. In one embodiment, the sizes and configuration of the various portions 1022-1028 are such that the recess 1020 can receive a laptop computer. However the size and configuration of recess 1020 may be such to accommodate a personal computer, PDA, mobile phone, tablet computer, electric razor, and any other items that may be realized by persons of ordinary skill in the art.

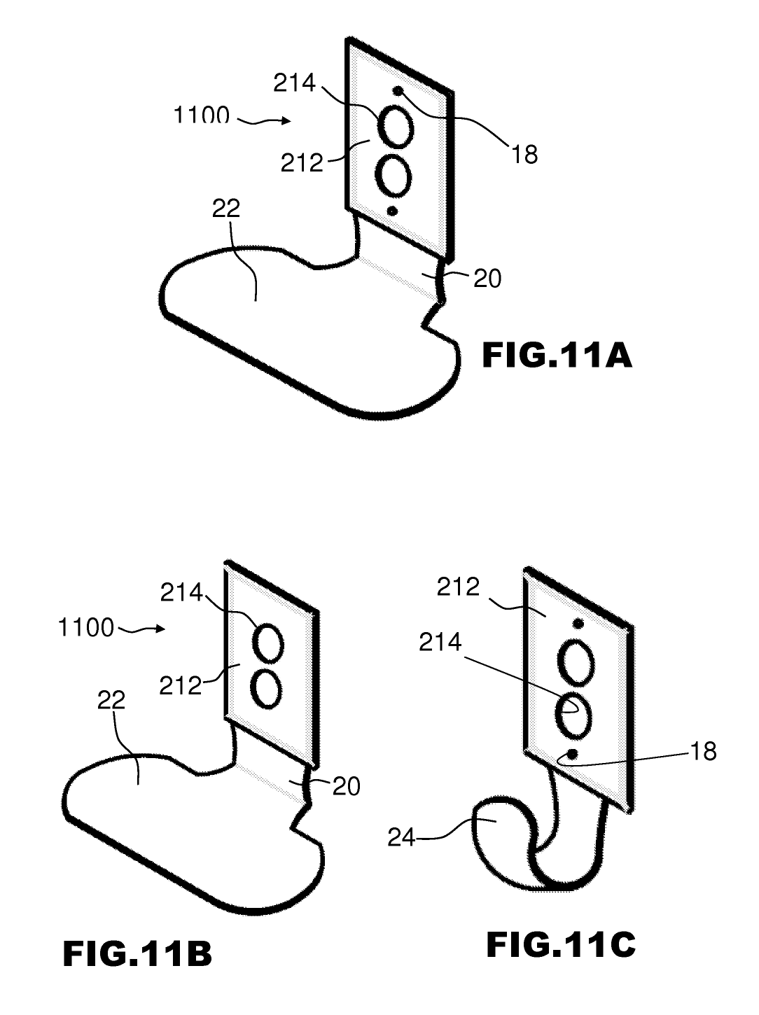

Still further embodiments of outlet covers 1100A, 1100B, and 1100C are illustrated in FIGS. 11A-11C. Outlet covers 1100A, 1100B, and 1100C are similar to other embodiments of outlet covers, but include circular outlet apertures 214. Outlet covers 1100A, 1100B, and 1100C are configured to replace the outlet cover on 360 Electrical's rotating duplex outlet, which has sockets that are rotatable three hundred sixty degrees. The rotating duplex outlet is the subject of U.S. Pat. Nos. 7,238,028, 7,125,056, and 7,121,834, each of which is incorporated herein by reference.

As mentioned earlier, it is contemplated that an outlet cover may include a shelf without the inclusion of an extension member. FIG. 12 illustrates one example of such an embodiment, wherein shelf 122 extends directly from the bottom of the plate member 12.

It is contemplated that the dimensions of the plate portion 12, 112 and associated apertures, 14, 15, 16 may vary based on the needs of the user, and so that the plate portion 12, 112 matches and fully covers the respective power outlet to which it is attached. In some embodiments, the width of the plate portion 12 may be longer than the height of the plate portion 12, and vice versa.

Exploded views of outlet covers 1300A-1300B are illustrated in perspective exploded views in FIGS. 13, illustrated with fasteners 32 that extend through apertures 18 of plate 12 and into apertures 31 in power outlet 30.

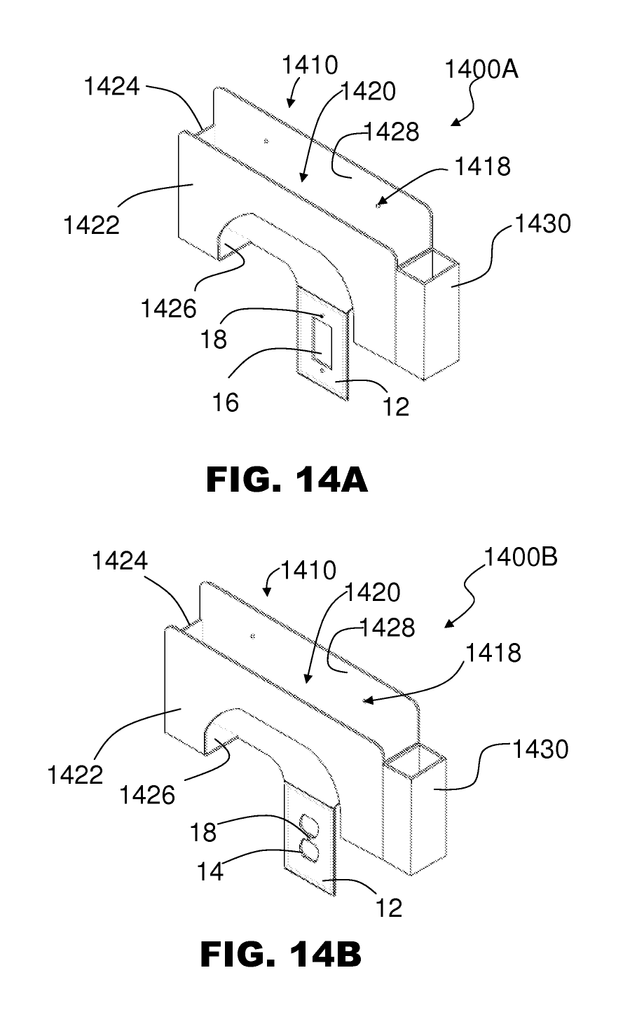

Referring now to FIGS. 14A-14B, perspective views of an outlet cover 1400A, 1400B are shown. The outlet cover 1400A may comprise a plate portion 12, at least one outlet aperture 16, at least one fastener aperture 18, and a laptop computer holder 1410. The outlet cover 1400B may comprise a plate portion 12, at least one outlet aperture 14, at least one fastener aperture 18, and a laptop computer holder 1410.

The laptop holder 1410 may comprise a recess 1420 that receives a laptop computer (not shown) such that the laptop is supported within the recess while it is charging. In one embodiment, the recess 1420 may be formed by front wall 1422, side braces 1424, bottom supports 1426, and rear wall 1428. As illustrated in FIGS. 14A-14B, the rear wall 1428 may be contiguous or attached to plate portion 12. In these embodiments, the plate portion 12 and the rear wall 1428 may be joined by any means that may be realized by persons of ordinary skill in the art such as gluing, heating, melting, stamping, and pressing. Alternatively, the rear wall 1428 and plate portion 12 may be monolithic.

Furthermore, the plate portion 12, the front wall 1422, the side braces 1424, the bottom wall 1426, and the rear wall 1428 may also be joined by the means stated above, formed monolithically, or any combination of the two. The plate portion 12, the front wall 1422, the side braces 1424, the bottom wall 1426, and the rear wall 1428 may be constructed of a plastic material such as polyethylene, polyvinyl chloride, and any number of materials that may be realized by persons of ordinary skill in the art. With reference to FIG. 14A, in this embodiment 1400A, the outlet aperture 16 is a single aperture, but more and different shaped apertures may be utilized depending on the number and shape of apertures required. Embodiment 1400B, for example, comprises two outlet apertures 14. The size of the aperture 16 may also be large enough to comfortably fit around the outer edge of a power socket or light switch.

Outlet covers 1400A, 1400B may comprise a plurality of fastener apertures, which receive fasteners to secure the outlet cover 1400A, 1400B to the power outlet and optionally to a wall. The fasteners 18 in the plate portion 12 may be similar to those in other embodiments, and may include a hole or opening that receives a screw, nail, staple, or any other material that may be realized by persons of ordinary skill in the art to secure the outlet cover 1400A, 1400B to a power outlet. However, embodiments 1400A, 1400B may additionally comprise one or more optional fastener apertures 1418 that provide additional support to outlet cover 1400A, 1400B. Apertures 1418 may receive a screw, nail, staple, or any other material that may be realized by persons of ordinary skill in the art to secure the outlet cover 1400A, 1400B to, for example, a wall. In order to allow fastener apertures 1418 to the wall, it is contemplated that rear wall 1428 may be at least slightly taller than front wall 1422, with apertures 1418 located above the upper extent of front wall 1422. At least one of the fastener apertures 1418 optionally may be configured to overlay the wall stud to which the power outlet attaches, and therefore a fastener extending through the particular aperture can engage the wall stud, to provide a secure attachment for outlet cover 1400A, 1400B and support for heavy objects.

Also, in these embodiments 1400A, 1400B, the side brace 1424 comprises two side braces 1424, one on each side, but more side braces 1424 or larger side braces may be utilized. For example, the side brace may simply be a continuous side wall that extends from the upper end of the front wall 1422 to the bottom wall 1426. Additionally, as illustrated, the bottom supports 1426 may have a space between them so that the power cord can extend from the laptop to the power outlet. In one embodiment, the sizes and configuration of the various portions 1422-1428 are such that the recess 1420 can receive a laptop computer. However the size and configuration may be such to accommodate a personal computer, PDA, mobile phone, tablet computer, electric razor, and any other items that may be realized by persons of ordinary skill in the art.

It is also envisioned in these embodiments 1400A, 1400B, that a holding compartment 1430 may be attached to one side brace 1424, but additional holding compartments 1430 or larger holding compartments may be utilized. For example, the holding compartment 1430 may simply be attached to another side brace 1424 or extend from the front wall front wall 1422. In one embodiment, the size and configuration of the holding compartment 1430 is such that it may receive a power converter/charger for a laptop computer; however, the size and configuration of the holding compartment 1430 may be such to receive any other items that may be realized by persons of ordinary skill in the art.

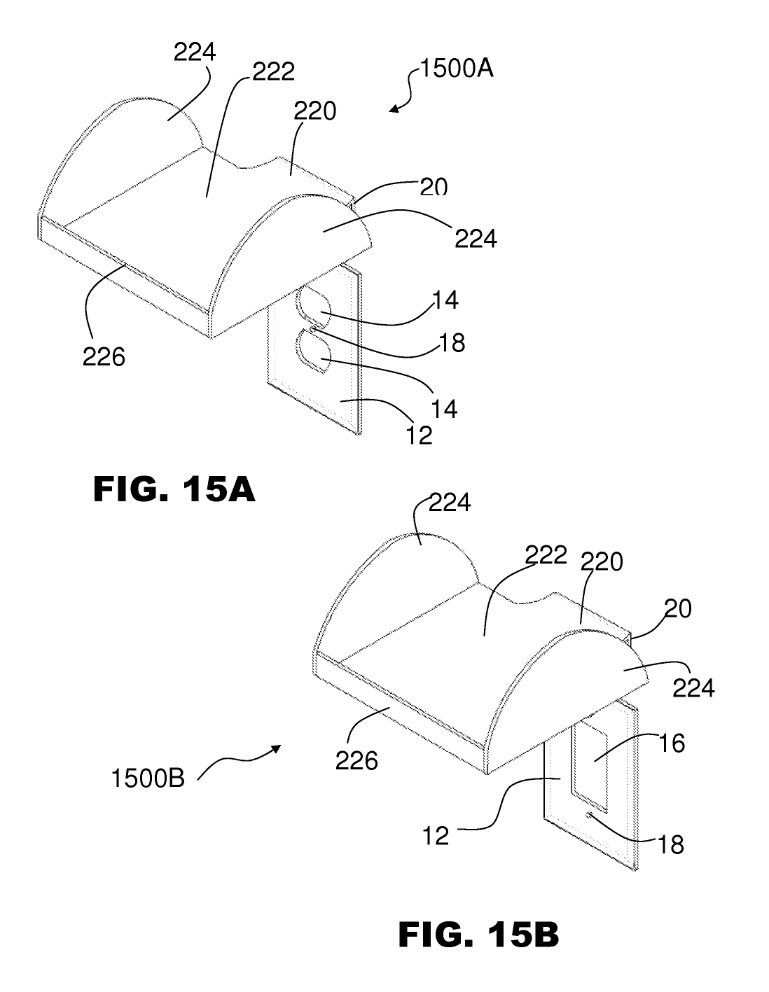

With reference to FIGS. 15A-15B, perspective views of an outlet covers 1500A and 1500B are shown. These embodiments may comprise an outlet cover with a shelf attached. Outlet cover 1500A may comprise a plate portion 12, at least one fastener aperture 18, a shelf portion 222, a first extension member 20, a second extension member 220, and at least one outlet aperture 14. Outlet cover 1500B may comprise a plate portion 12, at least one fastener aperture 18, a shelf portion 222, a first extension member 20, a second extension member 220, and at least one outlet aperture 16. In these embodiments, the plate portion 12, the extension members 20, 220, and the shelf 222 may be joined by any means that may be realized by persons of ordinary skill in the art such as gluing, heating, melting, stamping, and pressing. Alternatively, the plate portion 12, the extension members 20, 220, and the shelf 222 may be monolithic, or any combination of monolithic and joined. The plate portion 12, the shelf portion 222, and the extension members 20, 220 may also be constructed of a plastic material such as polyethylene, polyvinyl chloride, and any number of materials that may be realized by persons of ordinary skill in the art. As with all embodiments that include a shelf, it is also contemplated that extension members 20, 220 may be omitted, as previously described and illustrated in FIG. 12.

With continued reference to FIGS. 15A-15B, in these embodiments, the outlet aperture may be a combination of two apertures 14 (1500A), but more or less different shaped apertures may be utilized depending on the number and shape of apertures required, such as the single outlet aperture 16 of outlet cover 1500B. The size of the apertures 14 may also be large enough to comfortably fit around the outer edge of a power socket or light switch. Additionally, outlet cover 1500A may comprise a single fastener aperture 18, but more or less fasteners may be utilized depending on the amount of support necessary to support the outlet cover 1500A. The fastener aperture 18 may be a hole or opening that allows a screw, nail, staple, or any other material that may be realized by persons of ordinary skill in the art to secure the outlet cover 1500A to a power outlet.

The dimensions of the plate portion 12 of embodiments 1500A-1500B may vary so that the plate portion 12 may fully cover the power outlet. For example, the height of the plate portion 12 may be longer than the width of the plate portion 12, and vice versa. The dimensions of the shelf portion 222 may also vary depending on how large of a space is required. The shelf portion 222 may be large enough to support items such as candles, electric candle warmers, Palm Pilots, PDAs, hand held gaming systems, cell phones, walkie talkies, and any other items that may be realized by persons of ordinary skill in the art. In this embodiment, the shelf portion 222 may be rectangular and may have two sidewalls 224 and a front wall 226 extending upward from the upper surface of the shelf portion. As shown, the sidewalls 224 may have a curved upper surface and the front wall 226 may have a flat upper surface. However, it is envisioned that other top surface shapes of the walls 224, 226 may be utilized. It is also envisioned that the walls 224, 226 may include varying arrangements of decorative apertures cut therein, as well as other aesthetic embellishments. The upper surface of the shelf portion 22 may also be equipped with a non-slip surface such as silicone, anti-slip tapes, epoxy, anti-slip paint, polyurethane, and any other material that may be realized by persons of ordinary skill in the art.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

What is claimed is:

1. An outlet cover comprising:
(a) a plate member adapted to cover and be secured to a power outlet, the plate member including at least one fastener aperture and at least one outlet aperture; and
(b) at least one supporting structure extending from the plate portion, the supporting structure selected from the group consisting of a shelf portion, a hook, and a recess configured to receive an electronic device.

2. The outlet cover as defined in claim 1, wherein the at least one supporting structure is a shelf portion extending at an angle of about 90 degrees from the plate member.

3. The outlet cover as defined in claim 2, wherein the upper surface of the shelf portion includes a retaining member.

4. The outlet cover as defined in claim 3, wherein the retaining member is selected from the group consisting of silicon, anti-slip tape, epoxy, anti-slip paint, and polyurethane.

5. The outlet cover as defined in claim 3, wherein the retaining member is a wall extending upward from the surface of the shelf portion at the perimeter thereof.

6. The outlet cover as defined in claim 1, further comprising an extension member disposed between the plate member and the at least one supporting member.

7. The outlet cover as defined in claim 6, wherein the extension member includes at least one rib member.

8. An outlet cover comprising:
(a) a plate member adapted to cover a power outlet, the plate member including an interference fit mechanism configured to attach to a power outlet and at least one outlet aperture; and
(b) at least one supporting structure extending from the plate portion, the supporting structure selected from the group consisting of a shelf portion, a hook, and a recess configured to receive an electronic device.

9. The outlet cover as defined in claim 8, wherein the interference fit mechanism is a detent mechanism.

10. The outlet cover as defined in claim 8, wherein the at least one supporting structure is a shelf portion extending at an angle of about 90 degrees from the plate member.

11. The outlet cover as defined in claim 10, wherein the upper surface of the shelf portion includes a retaining member.

12. The outlet cover as defined in claim 11, wherein the retaining member is selected from the group consisting of silicon, anti-slip tape, epoxy, anti-slip paint, and polyurethane.

13. The outlet cover as defined in claim 11, wherein the retaining member is a wall extending upward from the surface of the shelf portion at the perimeter thereof.

14. The outlet cover as defined in claim 8, further comprising an extension member disposed between the plate member and the at least one supporting member.

15. The outlet cover as defined in claim 14, wherein the extension member includes at least one rib member.

16. A method of providing electrical power to a device, comprising the steps of:
(a) providing an outlet cover attached to a power outlet, the outlet cover including a plate member and at least one support structure integral with the plate member, the at least one support structure selected from the group consisting of a shelf portion, a hook, and a recess configured to receive an electronic device;
(b) placing an electrical device onto the support structure; and
(c) plugging the electrical device into the power outlet.

17. The method of providing electrical power to a device as defined in claim 16, wherein the at least one supporting structure is a shelf portion extending at an angle of about 90 degrees from the plate member.

18. The method of providing electrical power to a device as defined in claim 17 wherein the upper surface of the shelf portion includes a retaining member.

19. The method of providing electrical power to a device as defined in claim 16, further comprising an extension member disposed between the plate member and the at least one supporting member.

20. The method of providing electrical power to a device as defined in claim 19, wherein the extension member includes at least one rib member.
